(19) United States
(12) Patent Application Publication
(10) Pub. No.: US 2013/0254403 A1
(43) Pub. Date: Sep. 26, 2013

(54) VIRTUALIZATION SYSTEM, MANAGEMENT SERVER, MIGRATION METHOD, MIGRATION PROGRAM, AND VIRTUAL MACHINE MIGRATION METHOD TAKING INTER-BUSINESS COMMUNICATION INTO CONSIDERATION

(71) Applicant: Yukiharu TANIGUCHI, Tokyo (JP)

(72) Inventor: Yukiharu TANIGUCHI, Tokyo (JP)

(73) Assignee: NEC Corporation, Tokyo (JP)

(21) Appl. No.: 13/826,687

(22) Filed: Mar. 14, 2013

(30) Foreign Application Priority Data
Mar. 26, 2012 (JP) 2012-068727

(51) Int. Cl. H04L 12/70

(52) U.S. Cl. CPC H04L 47/783
USPC 709/226

(57) ABSTRACT

The virtualization system which realizes each business in an organization by a virtual machine, includes a plurality of physical servers each on which each virtual machine operates, and a management server which manages migration of the virtual machine, the management server including a migration management unit which manages migration of the virtual machine, wherein the migration management unit assumes the physical server in which the virtual machine exists as a reference physical server, and assumes the physical server whose number of network hops with the reference physical server is equal to or less than the maximum number of network hops set in advance to an organization to which a business linked with the virtual machine belongs as a candidate for a migration destination of the virtual machine.

### INCORPORATION BY REFERENCE

This application is based upon and claims the benefit of priority from Japanese patent application No. 2012-068727, filed on Mar. 26, 2012, the disclosure of which is incorporated herein in its entirety by reference.

### TECHNICAL FIELD

The present invention relates to a technique for determining a migration destination of a virtual machine and, more particularly, a technique for executing migration taking into consideration the number of network hops or the number of logical communication paths set up in a physical switching device after clarifying occurrence of communication between virtual machines based on an instruction from a virtual machine user or an organization to which the user belongs.

### BACKGROUND ART

Computer systems tend to be increased in size and are formed of a large number of switches or physical servers with virtual machines operating in large numbers. In migration of a virtual machine in such a state, lacking in consideration of a network structure or inter-business communication invites an increase in an unexpected network load and a reduction in business performance, so that SLA (Service Level Agreement) could not be guaranteed.

It is highly useful in operation or maintenance of a large-scale computer system to enable guarantee of SLA more reliably by clarifying and managing a network structure and inter-business communication of a business operating on a virtual machine.
Patent Literature 1: Japanese Patent Laying-Open No. 2011-243112
Patent Literature 2: Japanese Patent Laying-Open No. 2011-095871
Patent Literature 3: Japanese Patent Laying-Open No. 2009-116852
Patent Literature 4: Japanese Patent Laying-Open No. 2009-080692

With respect to migration of a virtual machine, a migration destination is determined based on a condition of loads on a physical machine according to the related art. In a case, therefore, where a business operating on a virtual machine to be migrated is a business having a 3-tier client server system, some structure of a network (physical switch) between physical machines on which each virtual machine having been migrated exists increases the number of network hops, which might invite an increase in a network load and a reduction in business performance.

### OBJECT OF THE INVENTION

An object of the present invention is to solve the above-described problems and provide a virtualization system which executes migration taking into consideration the number of network hops or the number of logical communication paths set up in a physical switching device after clarifying occurrence of communication between virtual machines based on an instruction from a virtual machine user or an organization to which the user belongs, and a management server, a migration method and a migration program therefor.

### SUMMARY

According to a first exemplary of the invention, a virtualization system which realizes each business in an organization by a virtual machine, comprises

a plurality of physical servers each on which each virtual machine operates, and a management server which manages migration of the virtual machine, the management server including a migration management unit which manages migration of the virtual machine, wherein the migration management unit assumes the physical server in which the virtual machine exists as a reference physical server, and assumes the physical server whose number of network hops with the reference physical server is equal to or less than the maximum number of network hops set in advance to an organization to which a business linked with the virtual machine belongs as a candidate for a migration destination of the virtual machine.

According to a second exemplary of the invention, in a virtualization system which realizes each business in an organization by a virtual machine on a physical server, a management server which manages migration of the virtual machine, comprises a migration management unit which manages migration of the virtual machine, wherein the migration management unit assumes the physical server in which the virtual machine exists as a reference physical server, and assumes the physical server whose number of network hops with the reference physical server is equal to or less than the maximum number of network hops set in advance to an organization to which a business linked with the virtual machine belongs as a candidate for a migration destination of the virtual machine.

According to a third exemplary of the invention, in a virtualization system which realizes each business in an organization by a virtual machine on a physical server, a migration method by a management server which manages migration of the virtual machine, comprises a migration management step of managing migration of the virtual machine, wherein the migration management step includes assuming the physical server in which the virtual machine exists as a reference physical server, and assuming the physical server whose number of network hops with the reference physical server is equal to or less than the maximum number of network hops set in advance to an organization to which a business linked with the virtual machine belongs as a candidate for a migration destination of the virtual machine.

According to a fourth exemplary of the invention, in a virtualization system which realizes each business in an organization by a virtual machine on a physical server, a computer-readable medium storing a migration program operable on a computer forming a management server which manages migration of the virtual machine, wherein the migration program causes the management server to execute migration management processing of managing migration of the virtual machine, wherein the migration management processing includes assuming the physical server in which the virtual machine exists as a reference physical server, and assuming the physical server whose number of network hops with the reference physical server is equal to or less than the maximum number of network hops set in advance to an organization to which a business linked with the virtual machine belongs as a candidate for a migration destination of the virtual machine.

The present invention enables execution of migration taking into consideration the number of network hops or the number of logical communication paths set up in a physical switching device after clarifying occurrence of communication between virtual machines based on an instruction from a virtual machine user or an organization to which the user belongs.

Other objects, features and advantages of the present invention will become clear from the detailed description given herebelow.

### BRIEF DESCRIPTION OF THE DRAWINGS

In the drawings:

FIG. 1 is a block diagram showing a structure of a virtualization system according to a first exemplary embodiment of the present invention;

FIG. 2 is a diagram showing an example of a structure of a structure table according to the first exemplary embodiment;

FIG. 3 is a diagram showing an example of a structure of the number of hops management table and the number of set up logical communication paths table according to the first exemplary embodiment;

FIG. 4 is a block diagram showing a structure of the virtualization system according to the first exemplary embodiment of the present invention;

FIG. 5 is a flow chart showing operation of the virtualization system according to the first exemplary embodiment of the present invention;

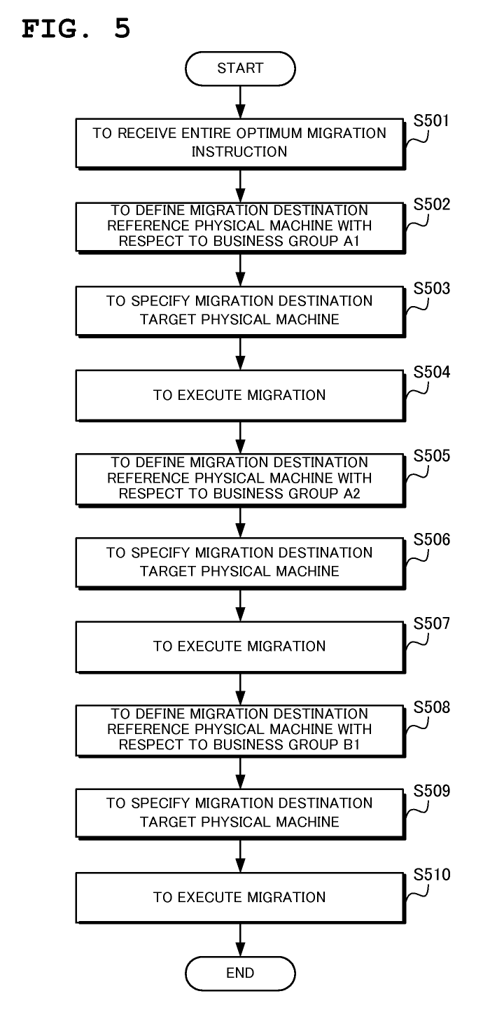

FIG. 6 is a block diagram showing a structure of a virtualization system according to a second exemplary embodiment of the present invention;

FIG. 7 is a flow chart showing operation of the virtualization system according to the second exemplary embodiment of the present invention;

FIG. 8 is a block diagram showing a minimum structure of a management server of the present invention; and

FIG. 9 is a block diagram showing an example of a hardware configuration of the management server of the present invention.

### EXEMPLARY EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

The present invention narrows down physical machines as a candidate for a migration destination by managing a physical environment, a virtual environment and a relation among virtual machines (communication or no communication between virtual machines) and then considering the number of network hops or the number of logical communication paths set up. Then, determining a migration destination based on a load condition realizes migration taking inter-business communication into consideration.

In order to clarify the foregoing and other objects, features and advantages of the present invention, exemplary embodiments of the present invention will be detailed in the following with reference to the accompanying drawings. Other technical problems, means for solving the technical problems and functions and effects thereof than the above-described objects of the present invention will become more apparent from the following disclosure of the exemplary embodiments. In all the drawings, like components are identified by the same reference numerals to appropriately omit description thereof.

### First Exemplary Embodiment

First exemplary embodiment of the present invention will be detailed with reference to the drawings.

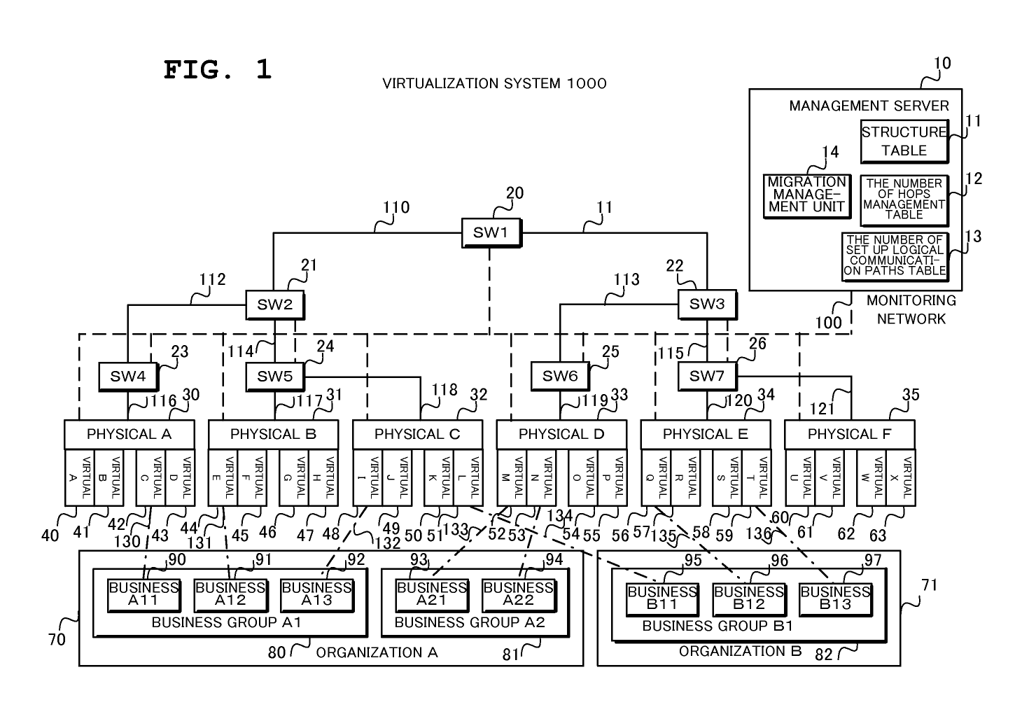

FIG. 1 is a block diagram showing a structure of a virtualization system 1000 according to the first exemplary embodiment of the present invention. The virtualization system 1000 according to the present embodiment includes a management server 10, physical machines 30 to 35, SWs 20 to 26, a monitoring network 100 and cables 110 to 121.

In the following, each unit shown in FIG. 1 will be detailed.

The management server 10 includes a structure table 11, the number of hops management table 12, the number of set up logical communication paths table 13 and a migration management unit 14.

The SWs 20 to 26 each have a plurality of input/output ports.

In the physical machines 30 to 35, a plurality of virtual machines are in operation. In the physical machine 30, virtual machines 40 to 43, in the physical machine 31, virtual machines 44 to 47, in the physical machine 32, virtual machines 48 to 51, in the physical machine 33, virtual machines 52 to 55, in the physical machine 34, virtual machines 56 to 59 and in the physical machine 35, virtual machines 60 to 63 are in operation, respectively.

The respective virtual machines in the physical machines 30 to 35 are used by organizations 70 and 71.

The organizations 70 and 71 each represent a tenant in a cloud system and correspond to a section/department or a company in real world. Organization has one or more business groups. The organization 70 has business groups 80 and 81 and the organization 71 has a business group 82.

The business groups 80 to 82 are an aggregation made of one or more businesses. Business included in the business group often has communication occurring between the businesses such as a 3-tier client server system. The business group 80 has businesses 90 to 92, the business group 81 has businesses 93 and 94 and the business group 82 has businesses 95 to 97.

The businesses 90 to 97 each represent an application operable on a virtual machine or the like. For example, the businesses have a 3-tier client server system to constitute one business group with the business 90 as a Web server, the business 91 as an application server operable by an instruction from the business 90, and the business 92 as a DB server operable by an instruction from the business 91.

To the monitoring network 100, the management server 10, the SWs 20 to 26 and the physical machines 30 to 35 are connected, with the management server 10 monitoring states of the SWs 20 to 26 and the physical machines 30 to 35.

The cables 110 to 121 are cables which connect SWs and physical machines.

Business operation places 130 to 137 represent on which virtual machine a business operates.

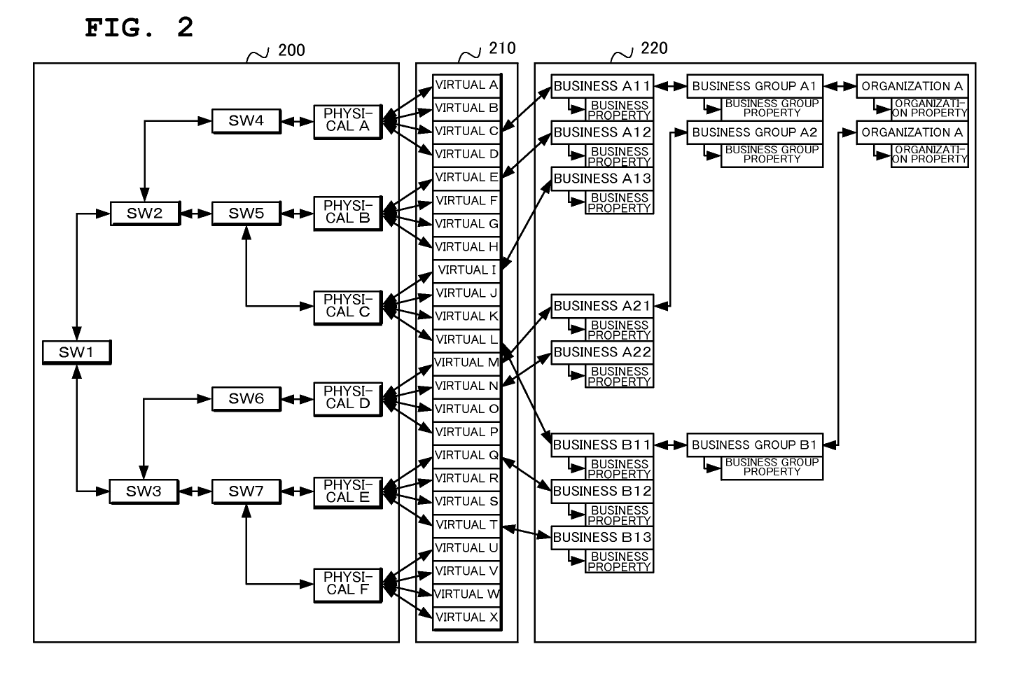

FIG. 2 shows details of the structure table 11 managed in the management server 10. With reference to FIG. 2, the structure table 11 includes a physical environment structure table 200, a virtual environment structure table 210 and a business environment structure table 220.

The physical environment structure table 200 manages structures of the physical machines and the SWs, which table is created by the management server 10 through the monitoring network 100 by using a network topology technique.

The virtual environment structure table 210 manages a structure of a virtual machine, and a relationship between each virtual machine and the physical machine, which table is created by the management server 10 by collecting information from a virtual environment management program (hypervisor) of a physical machine through the monitoring network 100.

The business environment structure table 220 manages structures of the organizations, business groups and businesses, and a relationship between each business and the virtual machine, which table is created by the management server 10 by collecting information from a business environment (cloud environment) management program of a physical machine through the monitoring network 100. Organization, business group and business each have a property. Properties of an organization and a business group manage setting of the maximum number of network hops and a property of a business manages setting of inter-business communication.

Arrows indicated in FIG. 2 each show a link state.

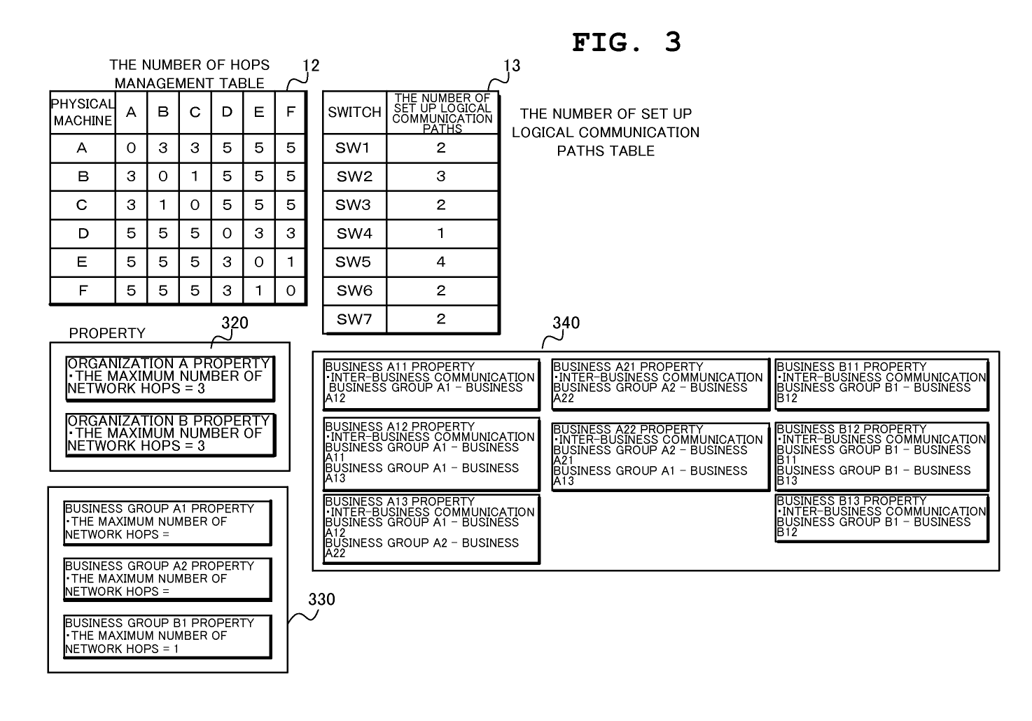

FIG. 3 shows structures of the number of hops management table 12 and the number of set up logical communication paths table 13 and properties of organizations, business groups and businesses (information about properties—attributes). Property of an organization is indicated in an organization property 320, a property of a business group is indicated in a business group property 330 and a property of a business is indicated in a business property 340, respectively.

The number of hops management table 12 manages the number of SWs through which communication between physical machines passes in inter-business communication and determines a load to be applied to the network according to the number of SWs through which communication passes. When the number of SWs through which communication passes is large, determine that a load to be applied to the network is heavy. The table is created by the management server 10 by using a network topology technique.

The number of set up logical communication paths table 13 manages the number of logical communication paths set up by the execution of inter-business communication for each SW and determines a load to be applied to the SW according to the number of logical communication paths set up. When the number of logical communication paths set up is large, determine that a load to be applied to the SW is heavy.

The number of set up logical communication paths table 13 is created by the management server 10 by using information of the business property 340. In a case, for example, where inter-business communication is executed between the business 90 (business A11) and the business 91 (business A12) in FIG. 1, determination can be made from the physical environment structure table 200, the virtual environment structure table 210 and the business environment structure table 220 in FIG. 2 that the communication passes through the SW23 (SW4), SW21 (SW2) and SW24 (SW5), so that the number of logical communication paths set up of the SW4, SW2 and SW5 of the number of set up logical communication paths table 13 is incremented by 1.

When inter-business communication is executed in the same physical machine 33, such as a case of the business 93 (business A21) and the business 94 (business A22) in FIG. 1, increment the number of logical communication paths set up of the SW25 (SW6) to which the physical machine 33 connects by 1.

The organization property 320 manages setting of the maximum number of network hops. Since a business belonging to an organization is highly probable to have inter-business communication, it is preferable for businesses belonging to an organization not to be physically away from each other even if no inter-business communication is executed. For realizing such arrangement, in the process of determining a migration destination, execute control not to determine more physical machines than the maximum number of network hops as a migration destination. The maximum number of network hops is set by a user's instruction. In preparation for a case of no instruction, set a default value in advance by a system provider.

The business group property 330 manages setting of the maximum number of network hops. Setting of the maximum number of network hops by a business group property is given priority over setting of the maximum number of network hops by the organization property 320. The maximum number of network hops is set by a user's instruction.

The business property 340 manages businesses of an inter-business communication partner. State of inter-business communication is set by a user's instruction. In a case, for example, where inter-business communication is executed between the business 90 (business A11) and the business 91 (business A12) in FIG. 1, set “business group A1-business A12” to be a communication partner as a business property of the business 90 (business A11) and set “business group A1-business A11” to be a communication partner as a business property of the business 91 (business A12).

### Description of Operation of the First Exemplary Embodiment

Next, description of operation of the virtualization system 1000 according to the present embodiment will be made with respect to operation executed at the time of optimum migration of the entire system taking inter-business communication into consideration as an example.

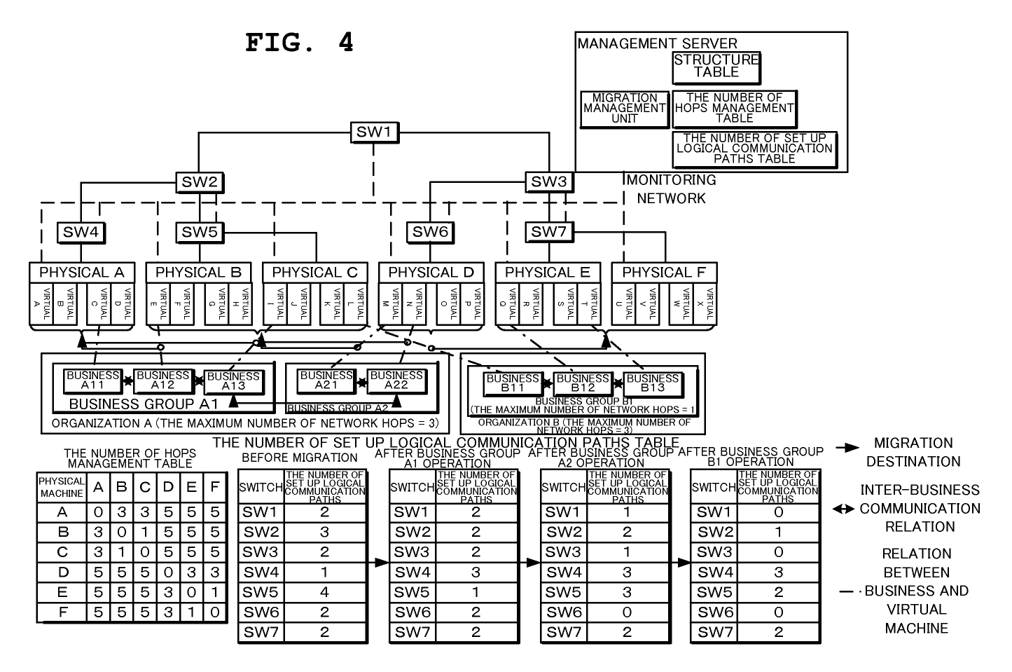

FIG. 4 mainly shows a state as of before migration.

Physical environments and virtual environments are as follows.

Physical machines are six, A to F, to form a network through the SW1 to SW7. The physical machines A to F each have four virtual machines, resulting in having a total of 24 virtual machines A to X.

Business environments are as follows.

Two organizations A and B exist as an organization. The organization A has two groups, business groups A1 and A2, the business group A1 having three businesses, businesses A11 to A13, and the business group A2 having two businesses, businesses A21 and A22. The organization B has one business group B1 which has three businesses, businesses B11 to B13.

Relationship between the businesses and the virtual machines is as follows.

The business A11 operates on the virtual machine C, the business A12 on the virtual machine E and the business A13 on the virtual machine I. The business A21 operates on the virtual machine M and the business A22 operates on the virtual machine N. The business B11 operates on the virtual machine L, the business B12 on the virtual machine Q and the business B13 on the virtual machine T.

Properties of the organizations are as follows.

The maximum number of network hops of the organization A is set to be 3 and the maximum number of network hops of the organization B is set to be 3.

Properties of the business groups are as follows.

The maximum number of network hops of the business group A1 is yet to be set, the maximum number of network hops of the business group A2 is yet to be set and the maximum number of network hops of the business group B1 is set to be 1.

Properties of the businesses are as follows.

The business A11 and the business A12, the business A12 and the business A13, the business A21 and the business A22, the business A22 and the business A13, the business B11 and the business B12, and the business B12 and the business B13 are set to have inter-business communication therebetween.

The number of network hops in communication between physical machines according to the above-described physical environments, virtual environments and business environments will be as shown in the number of hops management table and the number of logical communication paths set up will be as shown in the number of set up logical communication paths table as of before migration.

Next, operation of migration will be described with reference to the drawings.

First, the management server 10 receives an entire optimum migration instruction (Step S501).

Then, the migration management unit 14 of the management server 10 defines a migration destination reference physical machine with respect to the business group A1 of the organization A (Step S502). Since the three businesses belonging to the group exist in different physical machines, the migration management unit 14 defines the physical machine A in which the business A11 exists as a migration destination reference physical machine.

Next, the migration management unit 14 specifies a migration destination target physical machine (Step S503). Since the maximum number of network hops of the business group A1 is 3 which is defined in the organization A, the migration management unit 14 extracts a physical machine whose number of hops with the physical machine A is 3 or less from the number of hops management table 12 and specifies the extracted physical machine A, physical machine B and physical machine C as migration destination target physical machines.

Then, the migration management unit 14 executes migration execution processing (Step S504). The physical machine A, the physical machine B and the physical machine C are connected to the SW4 and the SW5, with the SW4 having a lighter load which can be seen from the number of set up logical communication paths table 13. Therefore, the migration management unit 14 executes migration execution processing with the physical machine A connected to the SW4 as a migration destination. As a result, the number of set up logical communication paths table 13 enters the state as of “after the business group A1 shift” shown in FIG. 4.

Since the business A13 of the business group A1 executes inter-business communication with the business A22 of the business group A2, continue to execute migration of the business group A2.

The migration management unit 14 defines a migration destination reference physical machine with respect to the business group A2 (Step S505). The migration management unit 14 defines the physical machine A in which the business A13 exists as a migration destination reference physical machine.

Next, the migration management unit 14 specifies a migration destination target physical machine (Step S506). Since the maximum number of network hops of the business group A1 is 3 which is defined in the organization A, the migration management unit 14 extracts a physical machine whose number of hops with the physical machine A is 3 or less from the number of hops management table 12 and specifies the extracted physical machine A, physical machine B and physical machine C as migration destination target physical machines.

Then, the migration management unit 14 executes migration execution processing (Step S507). The physical machine A, the physical machine B and the physical machine C are connected to the SW4 and the SW5, with the SW5 having a lighter load which can be seen from the number of set up logical communication paths table 13. Therefore, the migration management unit 14 executes migration execution processing with the physical machine B and the physical machine C connected to the SW5 as a migration destination. As a result, the number of set up logical communication paths table 13 enters the state as of “after the business group A2 shift” shown in FIG. 4.

Next, the migration management unit 14 defines a migration destination reference physical machine with respect to the business group B1 of the organization B (Step S508). The migration management unit 14 defines the physical machine E as a reference because two of the three businesses belonging to the business group B1 exist in the physical machine E.

Next, the migration management unit 14 specifies a migration destination target physical machine (Step S509). Since the maximum number of network hops of the business group B1 is 1, the migration management unit 14 extracts a physical machine whose number of hops with the physical machine E is one or less from the number of hops management table 12 and specifies the extracted physical machine E and physical machine F as migration destination target physical machines.

Then, the migration management unit 14 executes migration execution processing (Step S510). Since both the physical machine E and the physical machine F are connected to the SW7, determination of an SW load condition using the number of set up logical communication paths table is not required. Therefore, the migration management unit 14 executes migration execution processing with the physical machine E and the physical machine F as a migration destination. As a result, the number of set up logical communication paths table 13 enters the state as of “after the business group B1 shift” shown in FIG. 4.

### Effects of the First Exemplary Embodiment

The present exemplary embodiment has the effect of enabling more effective migration by eliminating a possibility that when in determining a migration destination, failing to consider inter-business communication will invite unexpected performance decrease.

There is a case where virtual machines in operation are put aside to turn off the power of physical machines in terms of saving power, the present exemplary embodiment enables putting aside virtual machines to be realized with ease taking the point of view of the network load into consideration in such a case.

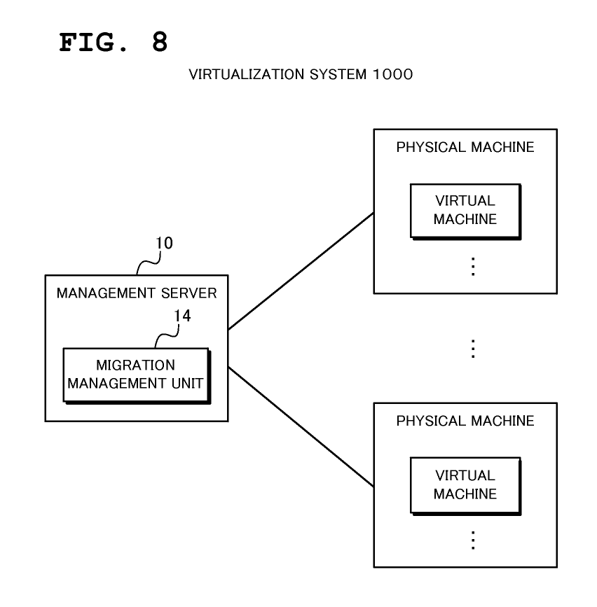

Minimum structure which enables the aims of the present invention to be attained is shown in FIG. 8. The above-described aims of the present invention can be attained by the virtualization system 1000 including a plurality of physical machines on which the virtual machines operate and the management server 10 which manages migration of the virtual machines, the management server 10 including the migration management unit 14 which manages migration of the virtual machines, in which the migration management unit 14 assumes a physical server on which a virtual machine exists as a reference physical server and a physical server whose number of network hops with the reference physical server is equal to or less than the maximum number of network hops set in advance to an organization to which a business linked with the virtual machine belongs as a candidate for a virtual machine migration destination.

### Second Exemplary Embodiment

Next, a second exemplary embodiment of the present invention will be detailed.

The present invention is also applicable to a case where a failure occurs in a physical environment.

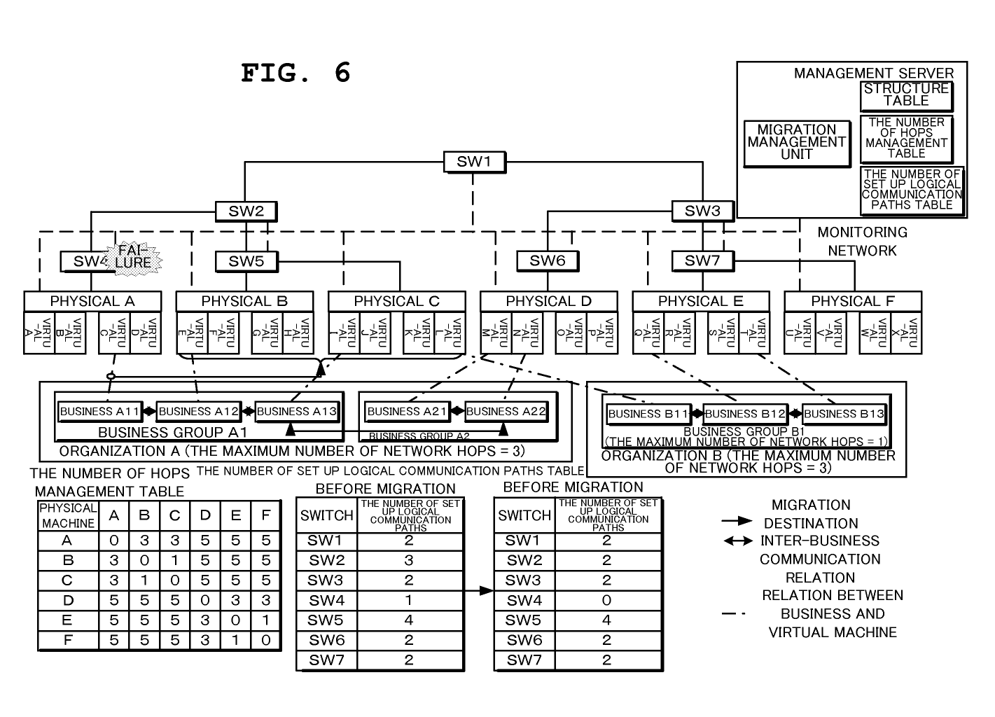

FIG. 6 mainly shows a state as of before migration. Physical environments, virtual environments and business environments are the same as those of the first exemplary embodiment. This is also the case with Examples.

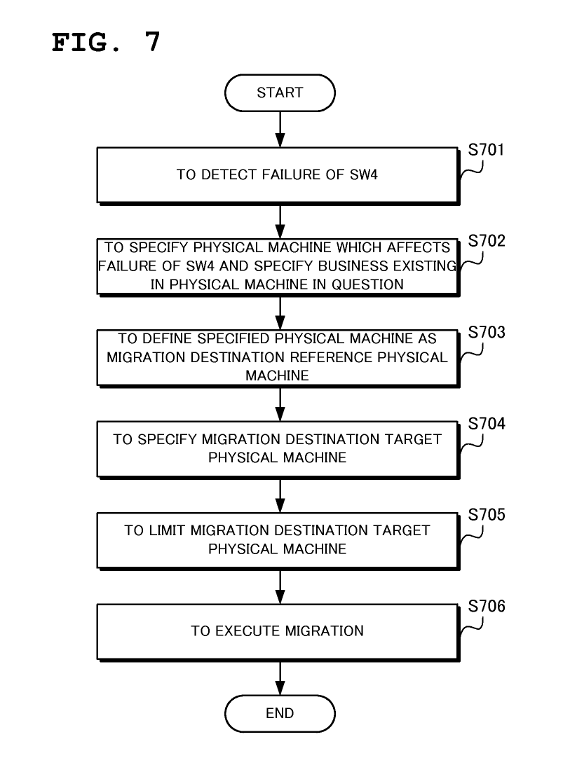

Description will be made of operation of migration with respect to a case where the SW4 develops a failure as an example with reference to the flow chart of FIG. 7.

First, the management server 10 detects a failure of the SW4 through the monitoring network (Step S701).

The migration management unit 14 subsequently specifies that the failure of the SW4 affects the physical machine A and specifies that the business A11 exists in the physical machine A (Step S702).

The migration management unit 14 subsequently specifies that the business A11 is to communicate with the business A12 to define the physical machine B in which the business A12 exists as a migration destination reference physical machine (Step S703).

Next, the migration management unit 14 specifies a migration destination target physical machine (Step S704). Since the maximum number of network hops of the business group A1 is 3 which is defined in the organization A, the migration management unit 14 specifies a physical machine whose number of hops with the physical machine B is 3 or less from the number of hops management table 12 as a migration destination target physical machine.

As a result, the migration destination target physical machines include the physical machine A, the physical machine B and the physical machine C. Since the physical machine A will be affected by the failure of the SW4, the migration management unit 14 limits the migration destination target physical machines to the physical machine B and the physical machine C (Step S705).

The migration management unit 14 subsequently executes migration execution processing (Step S706). Since both the physical machine B and the physical machine C are connected to the SW5, determination of an SW load condition using the number of set up logical communication paths table is not required. Therefore, the migration management unit 14 executes migration execution processing with the physical machine B and the physical machine C as a migration destination. As a result, the number of set up logical communication paths table 13 enters the state as of “after migration” shown in FIG. 6.

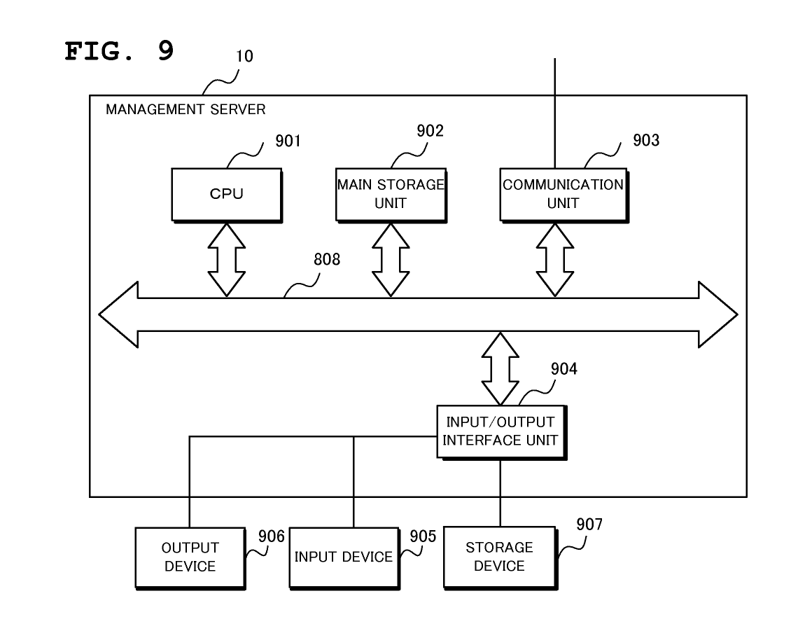

Next, an example of a hardware configuration of the management server 10 of the present invention will be described with reference to FIG. 9. FIG. 9 is a block diagram showing an example of a hardware configuration of the management server 10.

With reference to FIG. 9, the management server 10 of the present invention, which has the same hardware configuration as that of a common computer device, comprises a CPU (Central Processing Unit) 901, a main storage unit 902 formed of a memory such as a RAM (Random Access Memory) for use as a data working region or a data temporary saving region, a communication unit 903 which transmits and receives data through a network, an input/output interface unit 904 connected to an input device 905, an output device 906 and a storage device 907 to transmit and receive data, and a system bus 908 which connects each of the above-described components with each other. The storage device 907 is realized by a hard disk device or the like which is formed of a non-volatile memory such as a ROM (Read Only Memory), a magnetic disk or a semiconductor memory.

Each function of the management server 10 of the present invention has its operation realized not only in hardware by mounting a circuit part which is a hardware part such as an LSI (Large Scale Integration) with a program incorporated but also in software by storing a program which provides the function in the storage device 907, loading the program into the main storage unit 902 and executing the same by the CPU 901.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

An arbitrary combination of the foregoing components and conversion of the expressions of the present invention to/from a method, a device, a system, a recording medium, a computer program and the like are also available as a mode of the present invention.

In addition, the various components of the present invention need not always be independent from each other, and a plurality of components may be formed as one member, or one component may be formed by a plurality of members, or a certain component may be a part of other component, or a part of a certain component and a part of other component may overlap with each other, or the like.

While the method and the computer program of the present invention have a plurality of procedures recited in order, the order of recitation is not a limitation to the order of execution of the plurality of procedures. When executing the method and the computer program of the present invention, therefore, the order of execution of the plurality of procedures can be changed without hindering the contents.

Moreover, execution of the plurality of procedures of the method and the computer program of the present invention are not limitedly executed at timing different from each other. Therefore, during the execution of a certain procedure, other procedure may occur, or a part or all of execution timing of a certain procedure and execution timing of other procedure may overlap with each other, or the like.

Furthermore, a part or all of the above-described exemplary embodiments can be recited as the following claims but are not to be construed limitative.

The whole or part of the exemplary embodiments disclosed above can be described as, but not limited to, the following supplementary notes.

(Supplementary note 1.) A virtualization system which realizes each business in an organization by a virtual machine, comprising:

a plurality of physical servers each on which each virtual machine operates, and

a management server which manages migration of said virtual machine, said management server including a migration management unit which manages migration of said virtual machine, wherein said migration management unit

assumes said physical server in which said virtual machine exists as a reference physical server, and

assumes said physical server whose number of network hops with said reference physical server is equal to or less than the maximum number of network hops set in advance to an organization to which a business linked with said virtual machine belongs as a candidate for a migration destination of said virtual machine.

(Supplementary note 2.) The virtualization system according to supplementary note 1, wherein said management server includes the number of hops management table which manages the number of switches through which communication between said physical servers passes in inter-business communication as the number of network hops.

(Supplementary note 3.) The virtualization system according to supplementary note 1 or supplementary note 2, wherein said migration management unit determines said physical server whose number of logical communication paths in question of said switch is the smallest to which the physical server in question connects among said physical servers extracted as a migration destination.

(Supplementary note 4.) The virtualization system according to supplementary note 3, wherein said management server includes the number of set up logical communication paths table which manages the number of logical communication paths established by the execution of inter-business communication on said switch basis.

(Supplementary note 5. The virtualization system according to any one of supplementary note 1 through supplementary note 4, wherein said management server includes a physical environment structure table which manages structures of said switch and said physical machine.

(Supplementary note 6.) The virtualization system according to any one of supplementary note 1 through supplementary note 5, wherein said management server includes a virtual environment structure table which manages structures of said physical machine and said virtual machine.

(Supplementary note 7.) The virtualization system according to any one of supplementary note 1 through supplementary note 6, wherein said management server includes a business environment structure table which manages structures of an organization, a business group and a business, and a relation between said virtual machine and said business.

(Supplementary note 8.) The virtualization system according to any one of supplementary note 1 through supplementary note 7, wherein said migration management unit executes migration that optimizes arrangement of said virtual machine.

(Supplementary note 9.) The virtualization system according to any one of supplementary note 1 through supplementary note 7, wherein said migration management unit

executes migration when said switch develops a failure,

specifies said physical server which affects the failure of said switch,

specifies a business linked with the virtual machine in the physical server in question, and

assumes a physical machine in which a business communicating with the specified business exists as said reference physical server.

(Supplementary note 10.) In a virtualization system which realizes each business in an organization by a virtual machine on a physical server, a management server which manages migration of said virtual machine, comprising:

a migration management unit which manages migration of said virtual machine, wherein said migration management unit

assumes said physical server in which said virtual machine exists as a reference physical server, and

assumes said physical server whose number of network hops with said reference physical server is equal to or less than the maximum number of network hops set in advance to an organization to which a business linked with said virtual machine belongs as a candidate for a migration destination of said virtual machine.

(Supplementary note 11.) The management server according to supplementary note 10, comprising the number of hops management table which manages the number of switches through which communication between said physical servers passes in inter-business communication as the number of network hops.

(Supplementary note 12.) The management server according to supplementary note 10 or supplementary note 11, wherein said migration management unit determines said physical server whose number of logical communication paths in question of said switch is the smallest to which the physical server in question connects among said physical servers extracted as a migration destination.

(Supplementary note 13.) The management server according to supplementary note 12, comprising the number of set up logical communication paths table which manages the number of logical communication paths established by the execution of inter-business communication on said switch basis.

(Supplementary note 14.) The management server according to any one of supplementary note 10 through supplementary note 13, comprising a physical environment structure table which manages structures of said switch and said physical machine.

(Supplementary note 15.) The management server according to any one of supplementary note 10 through supplementary note 14, comprising a virtual environment structure table which manages structures of said physical machine and said virtual machine.

(Supplementary note 16.) The management server according to any one of supplementary note 10 through supplementary note 15, comprising a business environment structure table which manages structures of an organization, a business group and a business, and a relation between said virtual machine and said business.

(Supplementary note 17.) The management server according to any one of supplementary note 10 through supplementary note 16, wherein said migration management unit executes migration that optimizes arrangement of said virtual machine.

(Supplementary note 18.) The management server according to any one of supplementary note 10 through supplementary note 16, wherein

said migration management unit

executes migration when said switch develops a failure,

specifies said physical server which affects the failure of said switch,

specifies a business linked with the virtual machine in the physical server in question, and

assumes a physical machine in which a business communicating with the specified business exists as said reference physical server.

(Supplementary note 19.) In a virtualization system which realizes each business in an organization by a virtual machine on a physical server, a migration method by a management server which manages migration of said virtual machine, comprising:

the migration management step of managing migration of said virtual machine, wherein said migration management step includes

assuming said physical server in which said virtual machine exists as a reference physical server, and

assuming said physical server whose number of network hops with said reference physical server is equal to or less than the maximum number of network hops set in advance to an organization to which a business linked with said virtual machine belongs as a candidate for a migration destination of said virtual machine.

(Supplementary note 20.) The migration method according to supplementary note 19, wherein said migration management step includes extracting said physical server whose number of network hops with said reference physical server is equal to or less than the maximum number of network hops set in advance to an organization to which a business linked with said virtual machine belongs from the number of hops management table which manages the number of switches through which communication between said physical servers passes in inter-business communication as the number of network hops.

(Supplementary note 21.) The migration method according to supplementary note 19 or supplementary note 20, wherein said migration management step includes determining said physical server whose number of logical communication paths in question of said switch is the smallest to which the physical server in question connects among said physical servers extracted as a migration destination.

(Supplementary note 22.) The migration method according to supplementary note 21, comprising the step of managing the number of logical communication paths established by the execution of inter-business communication on said switch basis by the number of set up logical communication paths table.

(Supplementary note 23.) The migration method according to any one of supplementary note 19 through supplementary note 22, comprising the step of managing structures of said switch and said physical machine by a physical environment structure table.

(Supplementary note 24.) The migration method according to any one of supplementary note 19 through supplementary note 23, comprising the step of managing structures of said physical machine and said virtual machine by a virtual environment structure table.

(Supplementary note 25.) The migration method according to any one of supplementary note 19 through supplementary note 24, comprising the step of managing a business environment structure table which manages structures of an organization, a business group and a business, and a relation between said virtual machine and said business.

(Supplementary note 26.) The migration method according to any one of supplementary note 19 through supplementary note 25, wherein said migration management step includes executing migration that optimizes arrangement of said virtual machine.

(Supplementary note 27.) The migration method according to any one of supplementary note 19 through supplementary note 25, wherein said migration management step comprises

executing migration when said switch develops a failure,

specifying said physical server which affects the failure of said switch,

specifying a business linked with the virtual machine in the physical server in question, and

assuming a physical machine in which a business communicating with the specified business exists as said reference physical server.

(Supplementary note 28.) In a virtualization system which realizes each business in an organization by a virtual machine on a physical server, a migration program operable on a computer forming a management server which manages migration of said virtual machine, which

causes the management server to execute migration management processing of managing migration of said virtual machine, wherein said migration management processing includes

assuming said physical server in which said virtual machine exists as a reference physical server, and

assuming said physical server whose number of network hops with said reference physical server is equal to or less than the maximum number of network hops set in advance to an organization to which a business linked with said virtual machine belongs as a candidate for a migration destination of said virtual machine.

(Supplementary note 29.) The migration program according to supplementary note 28, wherein said migration management processing includes extracting said physical server whose number of network hops with said reference physical server is equal to or less than the maximum number of network hops set in advance to an organization to which a business linked with said virtual machine belongs from the number of hops management table which manages the number of switches through which communication between said physical servers passes in inter-business communication as the number of network hops.

(Supplementary note 30.) The migration program according to supplementary note 28 or supplementary note 29, wherein said migration management processing includes determining said physical server whose number of logical communication paths in question of said switch is the smallest to which the physical server in question connects among said physical servers extracted as a migration destination.

(Supplementary note 31.) The migration program according to supplementary note 30, which causes said computer to execute the processing of managing the number of logical communication paths established by the execution of inter-business communication on said switch basis by the number of set up logical communication paths table.

(Supplementary note 32.) The migration program according to any one of supplementary note 28 through supplementary note 31, which causes said computer to execute the processing of managing structures of said switch and said physical machine by a physical environment structure table.

(Supplementary note 33.) The migration program according to any one of supplementary note 28 through supplementary note 32, which causes said computer to execute the processing of managing structures of said physical machine and said virtual machine by a virtual environment structure table.

(Supplementary note 34.) The migration program according to any one of supplementary note 28 through supplementary note 33, which causes said computer to execute the processing of managing structures of an organization, a business group and a business, and a relation between said virtual machine and said business by a business environment structure table.

(Supplementary note 35.) The migration program according to any one of supplementary note 28 through supplementary note 34, wherein said migration management processing includes executing migration that optimizes arrangement of said virtual machine.

(Supplementary note 36.) The migration program according to any one of supplementary note 28 through supplementary note 34, wherein

said migration management processing includes

executing migration when said switch develops a failure,

specifying said physical server which affects the failure of said switch,

specifying a business linked with the virtual machine in the physical server in question, and

assuming a physical machine in which a business communicating with the specified business exists as said reference physical server.

### INDUSTRIAL APPLICABILITY

The present invention enables improvement in operation or maintenance of a large-scale computer system such as a cloud system.

What is claimed is:

1. A virtualization system which realizes each business in an organization by a virtual machine, comprising:
a plurality of physical servers each on which each virtual machine operates, and
a management server which manages migration of said virtual machine; said management server including a migration management unit which manages migration of said virtual machine,
wherein said migration management unit
assumes said physical server in which said virtual machine exists as a reference physical server, and
assumes said physical server whose number of network hops with said reference physical server is equal to or less than the maximum number of network hops set in advance to an organization to which a business linked with said virtual machine belongs as a candidate for a migration destination of said virtual machine.

2. The virtualization system according to claim 1, wherein said management server includes the number of hops management table which manages the number of switches through which communication between said physical servers passes in inter-business communication as the number of network hops.

3. The virtualization system according to claim 1 or claim 2, wherein said migration management unit determines said physical server whose number of logical communication paths in question of said switch is the smallest to which the physical server in question connects among said physical servers extracted as a migration destination.

4. The virtualization system according to claim 3, wherein said management server includes the number of set up logical communication paths table which manages the number of logical communication paths established by the execution of inter-business communication on said switch basis.

5. The virtualization system according to any one of claim 1 through claim 4, wherein said management server includes a physical environment structure table which manages structures of said switch and said physical machine.

6. The virtualization system according to any one of claim 1 through claim 5, wherein said management server includes a virtual environment structure table which manages structures of said physical machine and said virtual machine.

7. The virtualization system according to any one of claim 1 through claim 6, wherein said migration management unit
executes migration when said switch develops a failure,
specifies said physical server which affects the failure of said switch,
specifies a business linked with the virtual machine in the physical server in question, and
assumes a physical machine in which a business communicating with the specified business exists as said reference physical server.

8. In a virtualization system which realizes each business in an organization by a virtual machine on a physical server, a management server which manages migration of said virtual machine, comprising:
a migration management unit which manages migration of said virtual machine, wherein said migration management unit
assumes said physical server in which said virtual machine exists as a reference physical server, and
assumes said physical server whose number of network hops with said reference physical server is equal to or less than the maximum number of network hops set in advance to an organization to which a business linked with said virtual machine belongs as a candidate for a migration destination of said virtual machine.

9. In a virtualization system which realizes each business in an organization by a virtual machine on a physical server, a migration method by a management server which manages migration of said virtual machine, comprising:
a migration management step of managing migration of said virtual machine, wherein said migration management step includes
assuming said physical server in which said virtual machine exists as a reference physical server, and
assuming said physical server whose number of network hops with said reference physical server is equal to or less than the maximum number of network hops set in advance to an organization to which a business linked with said virtual machine belongs as a candidate for a migration destination of said virtual machine.

10. In a virtualization system which realizes each business in an organization by a virtual machine on a physical server, a computer-readable medium storing a migration program operable on a computer forming a management server which manages migration of said virtual machine, wherein said migration program
causes said management server to execute migration management processing of managing migration of said virtual machine,
wherein said migration management processing includes
assuming said physical server in which said virtual machine exists as a reference physical server, and
assuming said physical server whose number of network hops with said reference physical server is equal to or less than the maximum number of network hops set in advance to an organization to which a business linked with said virtual machine belongs as a candidate for a migration destination of said virtual machine.
